(19) United States
(12) Patent Application Publication
(10) Pub. No.: US 2015/0309233 A1
(43) Pub. Date: Oct. 29, 2015

(54) RETARDATION FILM AND FABRICATION METHOD THEREOF

(71) Applicant: FAR EASTERN NEW CENTURY CORPORATION, Taipei (TW)

(72) Inventors: Wei-Che Hung, Zhongli City (TW); Da-Ren Chiou, Zhongli City (TW); Yu-June Wu, Zhongli City (TW)

(21) Appl. No.: 14/576,267

(22) Filed: Dec. 19, 2014

(30) Foreign Application Priority Data
Apr. 25, 2014 (TW) 103114999

(51) Int. Cl. G02B 5/30

(52) U.S. Cl. CPC G02B 5/3016

(57) ABSTRACT

A method of fabricating a retardation film and a retardation film is provided. In the method, a primary transparent substrate is provided, and a liquid crystal aligning layer is formed over the primary transparent substrate, in which the liquid crystal aligning layer includes a first liquid crystal alignment region and a second liquid crystal alignment region interlacing with each other. A plurality of opacifier stripes are printed on a secondly transparent substrate, which the opacifier stripes are aligned with the interface between the first and second liquid crystal alignment regions. An adhesive layer is coated over the surface of the secondly transparent substrate and surfaces of the opacifier stripes. Further, the adhesive layer is bonded to the liquid crystal aligning layer, and then the liquid crystal aligning layer is separated from the primary transparent substrate.

### RELATED APPLICATIONS

This application claims priority to Taiwanese Application Serial Number 103114999, filed Apr. 25, 2014, which is herein incorporated by reference.

### BACKGROUND

1. Technical Field

The present invention relates to a method of fabricating a retardation film. More particularly, the present invention relates to a method of fabricating a retardation film having an alignment function.

2. Description of Related Art

In recent years, three dimensional (3D) display is a flourishing technology and one of the most important researches in the next generation display device. Fabricating and using the 3D retardation film therefore becomes the key point of the technology development.

Taiwan Patent No. 1233514 discloses a method of using a photo-alignment technology to fabricate the retardation film. A hard photomask (e.g., quartz) is applied to cover different regions of a liquid crystal layer, and different linearly-polarized lights are emitted to cure and transfer liquid crystal at different regions into different polarization directions and form a patterned retardation film. However, at least two photomasks are necessary to form the different polarization directions in the liquid crystal layer. The technique not only increases the costs of fabricating the photomask, but also decreases yield due to the restrict requirement of alignment accuracy. For example, the quality of the retardation film becomes poor when deviation occurs in the alignment. The photo-alignment technique may be operated by a special photomask having two different polarization directions, but the special photomask is expensive and size-limited such that the technique is hard to be applied in mass production. When using the photo-alignment technique to form two alignment regions, a light line may occur at the interface between the two regions due to the disorders of the liquid crystal. As such, a light leakage occurs and decreases the 3D display quality. In case of applying the hard photomask to fabricate the retardation film, the light is diffused which further expands the light line.

Japan Patent No. 2002185983 discloses a method of using a black paint to cover a non-aligned region at the interface between the two regions, and thus a vertical visual angle of the 3D display could be increased. Nevertheless, painting the black paint directly on a surface of the liquid crystal surface of the retardation film may cause liquid crystal defects. Furthermore, particles are possibly introduced after drying, which is apt to scratch or form defects on the liquid crystal surface and decreases the display quality. Also, because the retardation film has no apparent alignment mark thereon, the alignment becomes even more difficult.

In that the two traditional methods of fabricating a retardation film with two polarization directions have problems of low yield, alignment difficulty, and not applicable in a roll-to-roll process, it is necessary to investigate a new method of fabricating high-quality retardation film that is able to increase the alignment accuracy and be applied in the roll-to-roll process.

### SUMMARY

In view of the above, the present disclosure uses opacifier stripes having the black paints to cover the interface between two liquid crystal alignment regions having different polarization directions, to increase the vertical visual angle of the 3D display having the retardation film. The opacifier stripes are formed by a transferable pasting process, and an adhesive layer is applied to cover the opacifier stripes for avoiding a product defect caused by particles formation or falling off after drying the black paints. The fabricating method can apply in the roll-to-roll process, and the fabricating method could produce the high yield retardation film massively.

An aspect of the present invention provides a method of fabricating a retardation film, including following operations: A primary transparent substrate is provided, and an liquid crystal aligning layer is formed over a photo-alignment layer on the primary transparent substrate, which the liquid crystal aligning layer includes a first liquid crystal alignment region and a second liquid crystal alignment region, and the two liquid crystal alignment regions have different polarization directions and alternatively arranged with each other. A plurality of opacifier stripes are printed on a secondly transparent substrate, which the opacifier stripes align with the interface between the first liquid crystal alignment region and the second liquid crystal alignment region. An adhesive layer is coated over a surface of the secondly transparent substrate and surfaces of the opacifier stripes. The adhesive layer is bonded to the liquid crystal aligning layer, and the liquid crystal aligning layer is separated from the primary transparent substrate.

According to various embodiments of the present disclosure, the primary transparent substrate includes a first surface and a second surface opposite to the first surface, which the first surface includes an opacifier pattern, and the second surface includes a photo-orientable layer.

According to various embodiments of the present disclosure, forming the liquid crystal aligning layer over the photo-alignment layer of the primary transparent substrate includes following steps: A linearly-polarized ultraviolet light is irradiated to the photo-orientable layer to form the photo-alignment layer, which the photo-alignment layer includes a first photo-alignment region and a second photo-alignment region, and the two photo-alignment regions are alternatively arranged with each other. The liquid crystal aligning layer is formed over the photo-alignment layer, the liquid crystal aligning layer having a first liquid crystal alignment region and a second liquid crystal alignment region arranged alternatively with the first liquid crystal alignment region. The first liquid crystal alignment region is on the first photo-alignment region, and the second liquid crystal alignment region is on the second photo-alignment region.

According to various embodiments of the present disclosure, irradiating a linearly-polarized ultraviolet light to the photo-orientable layer to form the photo-alignment layer includes following operations: The photo-orientable layer is irradiated with a first linearly-polarized ultraviolet light having a first polarization direction through the primary transparent substrate in a direction from the first surface toward the second surface of the primary transparent substrate, which the photo-orientable layer irradiated by the first linearly-polarized ultraviolet light transfers into the first photo-alignment region. And the photo-orientable layer is irradiated with a second linearly-polarized ultraviolet light having a second polarization direction different from the first polarization direction through the primary transparent substrate in a direction from the second surface toward the first surface of the primary transparent substrate, which the photo-orientable layer not irradiated by the first linearly-polarized ultraviolet light transfers into the second photo-alignment region.

According to various embodiments of the present disclosure, irradiating the linearly-polarized ultraviolet light to the photo-orientable layer to form the photo-alignment layer is by irradiating the photo-orientable layer with the first linearly-polarized ultraviolet light before irradiating the photo-orientable layer with the second linearly-polarized ultraviolet light, and an accumulated exposure dose of the first linearly-polarized ultraviolet light on the photo-orientable layer is higher than an accumulated exposure dose of the second linearly-polarized ultraviolet light on the photo-orientable layer.

According to various embodiments of the present disclosure, irradiating the linearly-polarized ultraviolet light to the photo-orientable layer to form the photo-alignment layer is by irradiating the photo-orientable layer with the second linearly-polarized ultraviolet light before irradiating the photo-orientable layer with the first linearly-polarized ultraviolet light, and an accumulated exposure dose of the first linearly-polarized ultraviolet light on the photo-orientable layer is higher than or equal to an accumulated exposure dose of the second linearly-polarized ultraviolet light on the photo-orientable layer.

According to various embodiments of the present disclosure, the second polarization direction of the second linearly-polarized ultraviolet light is perpendicular to the first polarization direction of the first linearly-polarized ultraviolet light during irradiating the linearly-polarized ultraviolet light to the photo-orientable layer to form the photo-alignment layer.

According to various embodiments of the present disclosure, forming the liquid crystal aligning layer over the photo-alignment layer includes following operations: A liquid crystal material layer is formed over the photo-alignment layer, and an ultraviolet light is irradiated to the liquid crystal material layer to form the liquid crystal aligning layer, which an polarization direction of the liquid crystal aligning layer is same with that of the photo-alignment layer.

According to various embodiments of the present disclosure, a material of the opacifier stripe includes an ultraviolet radiation absorbing agent or a light-shielding ink.

According to various embodiments of the present disclosure, a width of the opacifier stripe is in a range from about from 40 to about 120 μm.

According to various embodiments of the present disclosure, a material of the adhesive layer is a transparent pressure-sensitive adhesive.

According to various embodiments of the present disclosure, the transparent pressure-sensitive adhesive is selected form a group consisting of an acrylic pressure-sensitive adhesive, a polyurethane pressure-sensitive adhesive, a polyisobutylene pressure-sensitive adhesive, a rubber-based pressure-sensitive adhesive (such as styrene-butadiene rubber), a polyvinyl ether pressure-sensitive adhesive, an epoxy pressure-sensitive adhesive, a melamine pressure-sensitive adhesive, a polyester pressure-sensitive adhesive, a phenol pressure-sensitive adhesive, a silicon pressure-sensitive adhesive, and combinations thereof.

According to various embodiments of the present disclosure, a material of the primary and the secondly transparent substrates is selected form a group consisting of a polyester-based resin, a acetate-based resin, a polyethersulfone-based resin, a polycarbonate-based resin, a polyamide-based resin, polyimide-based resin, a polyolefin-based resin, an acrylic-based resin, a polyvinyl chloride-based resin, a polystyrene-based resin, a polyvinyl alcohol-based resin, a polyarylate-based resin, a polyphenylene sulfide-based resin, a polyvinylidene chloride-based resin, and a methacrylate-based resin.

According to various embodiments of the present disclosure, a material of the primary and the secondly transparent substrates includes cellulose triacetate or polycarbonate.

According to various embodiments of the present disclosure, a material of the photo-orientable layer includes a photo-orientable resin.

According to various embodiments of the present disclosure, the photo-orientable resin is selected from a group consisting of cinnamate derivatives, chalcone derivatives, maleimide derivatives, quinolinone derivatives, diphenylmethylene derivatives and coumarin derivatives.

According to various embodiments of the present disclosure, a material of the opacifier pattern comprises an ultraviolet radiation absorbing agent or a light-shielding ink.

Another aspect of the present disclosure provides a retardation film. The retardation film includes an liquid crystal aligning layer having a first liquid crystal alignment region and a second liquid crystal alignment region, which the two liquid crystal alignment regions have different polarization directions and alternatively arranged with each other. An adhesive layer is disposed on the liquid crystal aligning layer, and a transparent substrate is disposed on the adhesive layer. A plurality of opacifier stripes are disposed on a surface between the transparent substrate and the adhesive layer, which the opacifier stripes are on the boundary between the first liquid crystal alignment region and the second liquid crystal alignment region, and the opacifier stripes are not in contact with the liquid crystal aligning layer.

According to various embodiments of the present disclosure, a width of the opacifier stripes is in a range from about 1 to about 5 μm.

According to various embodiments of the present disclosure, a width of the opacifier stripes is in a range from about 40 to about 120 μm.

According to various embodiments of the present disclosure, a thickness of the adhesive layer is in a range from about 10 to about 30 μm.

According to various embodiments of the present disclosure, a material of the opacifier stripe includes an ultraviolet radiation absorbing agent or a light-shielding ink.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIGS. 1-9 are cross-sectional views at various stages of fabricating the retardation film, in accordance with some embodiments;

FIG. 10 is a cross-sectional view of the retardation film, in accordance with some embodiments;

FIG. 11 is a cross-sectional view of the retardation film, in accordance with example 1;

FIG. 12 is a cross-sectional view of the retardation film, in accordance with example 2; and

FIG. 13 is a cross-sectional view of the retardation film, in accordance with example 3.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

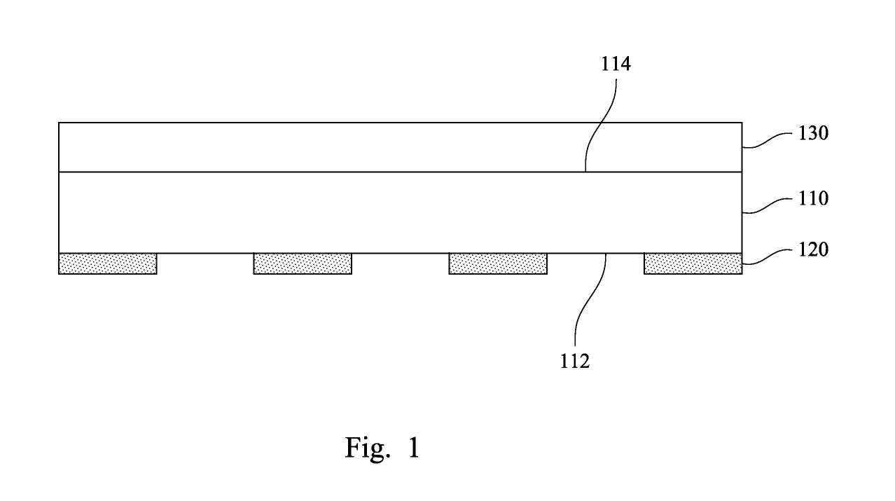

Referring to FIGS. 1-9, FIGS. 1-9 are cross-sectional views at various stages of fabricating a retardation film, in accordance with various embodiments. Referring to FIG. 1, FIG. 1 depicts a step of providing a primary transparent substrate 110. The primary transparent substrate 110 includes a first surface 112 and a second surface 114 opposite to the first surface 112, which the first surface 112 includes an opacifier pattern 120, and the second surface includes a photo-orientable layer 130. A material of the primary transparent substrate 110 is a flexible and transparent material. In some embodiments, the material of the primary transparent substrate 110 is selected form a group consisting of a polyester-based resin, a acetate-based resin, a polyethersulfone-based resin, a polycarbonate-based resin, a polyamide-based resin, polyimide-based resin, a polyolefin-based resin, an acrylic-based resin, a polyvinyl chloride-based resin, a polystyrene-based resin, a polyvinyl alcohol-based resin, a polyarylate-based resin, a polyphenylene sulfide-based resin, a polyvinylidene chloride-based resin, and a methacrylate-based resin, but not limited thereto. In some embodiments, the material of the primary transparent substrate 110 includes cellulose triacetate or polycarbonate.

The opacifier pattern 120 may be formed by mixing a light-shielding material, an adhesive, and a solvent, then printing the mixture on the first surface 112 of the primary transparent substrate 110 to form the opacifier pattern 120 in accordance to the desired design. In some embodiments, the adhesive is a thermoset adhesive. The light-shielding material adsorbs or reflects the light wavelength desired to be filtered, and any light-shielding material in the technical field known by the person skilled in the art could be used. In embodiments, the opacifier pattern 120 includes an ultraviolet radiation absorbing agent or a light-shielding ink, but not limited thereto. In various embodiments, the ultraviolet radiation absorbing agent includes benzophenone or benzotriazole, but not limited thereto. In various embodiments, the light-shielding ink includes carbon black, graphite, azo dye or phthalocyanine dye, but not limited thereto. In some embodiments, the opacifier pattern 120 may be formed on the first surface 112 by, but not limited to, screen printing, gravure printing or ink spraying, according to the fabricating convenience of different embodiments. In various embodiments, the opacifier pattern 120 has strip-shape patterns arranged in parallel on the first surface 112. In embodiments, a width of the opacifier pattern 120 is in a range from about 500 μm to about 700 μm.

A material of the photo-orientable layer 130 is a photo-alignment resin. The photo-alignment resin includes photo-induced isomerization resin, photo-induced crosslinking resin and photo-induced decomposition resin, which may be chose according to the fabricating convenience. In some embodiments, the material of the photo-orientable layer 130 is the photo-induced crosslinking resin. The photo-induced crosslinking resin includes, but not limited to, cinnamate-based resin, coumarin-based resin, chalcone-based resin, maleimide-based resin, quinolinone-based resin, bis(benzylidene)-based resin, or a combination thereof. The method of forming the photo-orientable layer 130 on the second surface 114 is not limited, the method could be selected according to the fabricating convenience of different embodiments. For example, spin coating, bar coating, dip coating, slot coating, screen printing, or gravure printing.

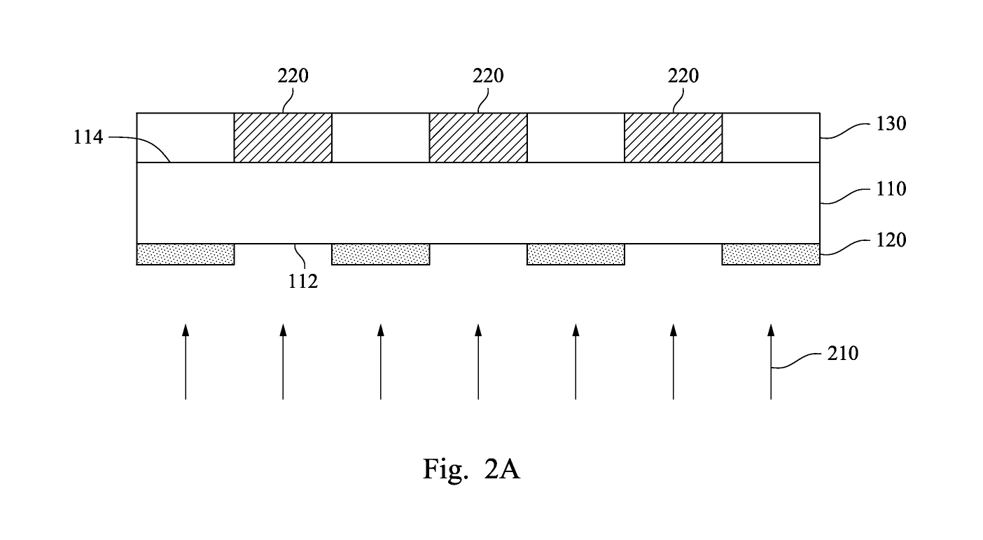

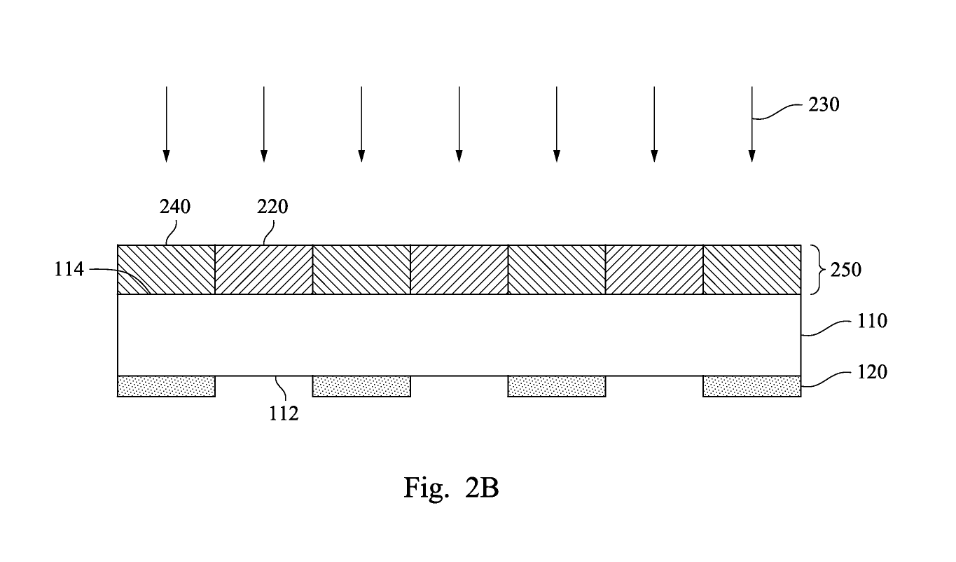

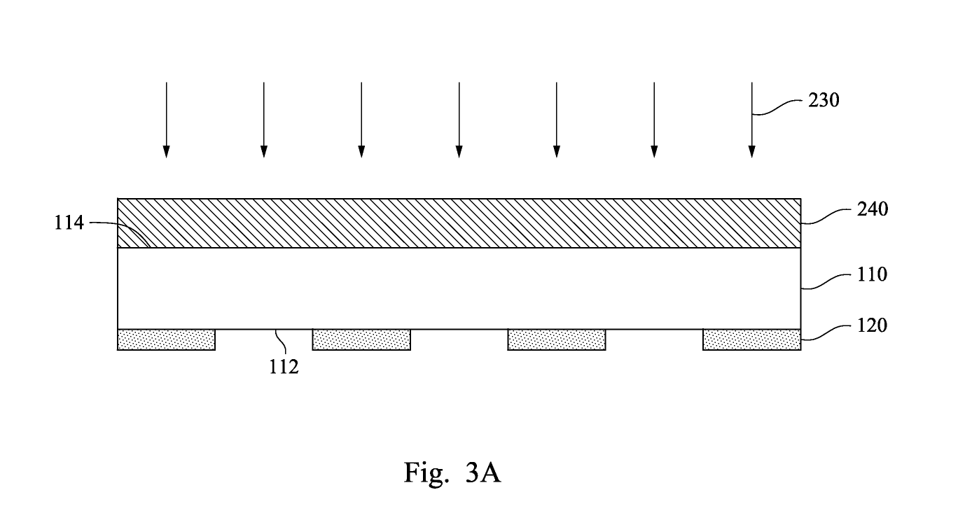

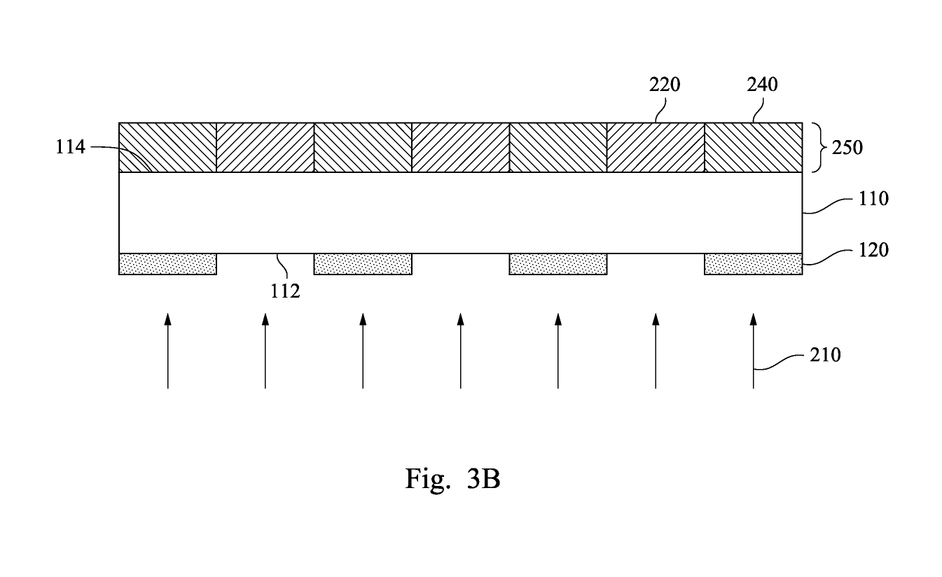

Referring to FIGS. 2A, 2B and FIGS. 3A, 3B, FIGS. 2A, 2B and FIG. 3A, 3B depict two different embodiments of the step of irradiating linearly-polarized ultraviolet lights to the photo-orientable layer to form the photo-alignment layer. Referring to FIG. 2A, FIG. 2A depicts a step of irradiating the photo-orientable layer 130 with a first linearly-polarized ultraviolet light 210 having a first polarization direction, which the first linearly-polarized ultraviolet light 210 is in a direction from the first surface 112 toward the second surface 114 of the primary transparent substrate 110. A region of the photo-orientable layer 130 irradiated by the first linearly-polarized ultraviolet light 210 transfers to a first photo-alignment region 220. The linearly-polarized ultraviolet light is a plane-polarized ultraviolet light having a single linear-polarizing direction, and is obtained by passing a non-linearly-polarized light through a polarizer only permitting one predetermined direction of the linearly-polarized light to pass through. In some embodiments, the polarizer is a polarizing film or an optical grid. Because the first linearly-polarized ultraviolet light 210 has the first polarization direction. When the first linearly-polarized ultraviolet light 210 irradiates to the photo-orientable layer 130, the molecules in an irradiated region of the photo-orientable layer 130 are affected by the first linearly-polarized ultraviolet light 210 to rearrange along the same polarization direction with the first polarization direction, and the first photo-alignment region 220 is formed. In some embodiments, the photo-alignment resin of the photo-orientable layer 130 is photo-induced cross-linking resin. With irradiating the linearly-polarized ultraviolet light with an irradiation dosage no less than 5 mJ/cm², the photo-induced cross-linking resin will be aligned by a photochemical reaction.

When irradiating the first linearly-polarized ultraviolet light 210 to the photo-orientable layer 130 from the first surface 112 to the second surface 114, the opacifier pattern 120 hinders part of the first linearly-polarized ultraviolet light 210. Therefore, the photo-orientable layer 130 not covered by the opacifier pattern 120 will be irradiated by the first linearly-polarized ultraviolet light 210. The region of the photo-orientable layer 130 irradiated by the first linearly-polarized ultraviolet light 210 transfers to the first photo-alignment region 220 having a polarization direction same with the first polarization direction, due to the cross-linking of the photo-induced cross-linking resin.

Please refer to FIG. 2B, FIG. 2B depicts a step of irradiating the photo-orientable layer 130 with a second linearly-polarized ultraviolet light 230, which has a second polarization direction different from the first polarization direction. The second linearly-polarized ultraviolet light 230 passes through the primary transparent substrate 110 in a direction from the second surface 114 toward the first surface 112 of the primary transparent substrate 110, to form a second photo-alignment region 240 from the photo-orientable layer 130. In some embodiments of the present disclosure, the second linearly-polarized ultraviolet light 230 has a different polarization direction with the first linearly-polarized ultraviolet light 210, and a slow axis of the primary transparent substrate 110 forms an angle of zero degree or 90 degrees with the polarization direction of the first linearly-polarized ultraviolet light 210 and the second linearly-polarized ultraviolet light 230. When irradiating the second linearly-polarized ultraviolet light 230 to the photo-orientable layer 130, since the part of the photo-orientable layer 130 has transferred to the first photo-alignment region 220, the accumulated irradiation energy of second linearly-polarized ultraviolet light 230 on the photo-orientable layer 130 should be lower than the accumulated irradiation energy of the first linearly-polarized ultraviolet light 210 on the photo-orientable layer 130, to avoid the already aligned first photo-alignment region 220 changing the polarization direction by the second linearly-polarized ultraviolet light 230. Besides, the region of the photo-orientable layer 130 without a polarization direction will transfer into a second photo-alignment region 240 having a second polarization direction. Furthermore, in some embodiments of the present invention, the accumulated irradiation energy of the first and second linearly-polarized ultraviolet light 210, 230 is less than 500 mJ/cm². Since a higher accumulated irradiation energy requires a longer exposure time, which will have an adverse effect on a roll-to-roll process and increase energy consumption and manufacturing costs. The dosage is defined as: a time integration value of the exposure dosage of the linearly-polarized ultraviolet light per unit area of the photo-alignment layer 130 in a single exposure. In some embodiments of the present invention, the irradiation dosage of the first linearly-polarized ultraviolet light 210 is 180 mJ/cm², and the irradiation dosage of the second linearly-polarized ultraviolet light 230 is 90 mJ/cm². After irradiating with the first and second linearly-polarized ultraviolet lights 210, 230, the photo-orientable layer 130 transfers into a photo-alignment layer 250 with a first alignment region 220 and a second alignment region 240. The arrangement of the first alignment region 220 and the second alignment region 240 in the photo-alignment layer 250 is a staggered arrangement. The photo-alignment layer 250 allows the liquid crystal material coated thereon aligning along the polarization direction, which forms alignment of the liquid crystal material.

Please refer to FIGS. 3A and 3B. The differences of embodiments in FIG. 3A, 3B and FIG. 2A, 2B are described below. The embodiments in FIGS. 2A and 2B starts with irradiating the first linearly-polarized ultraviolet light 210, but embodiments in FIGS. 3A and 3B starts with irradiating the second linearly-polarized ultraviolet light 230. Referring to FIG. 3A, FIG. 3A depicts step of irradiating the photo-orientable layer 130 with the second linearly-polarized ultraviolet light 230 having a second polarization direction, which the second linearly-polarized ultraviolet light 210 is irradiated in a direction from the first surface 112 toward the second surface 114 of the primary transparent substrate 110. A region of the photo-orientable layer 130 irradiated by the second linearly-polarized ultraviolet light 230 forms a second photo-alignment region 240. Since there is no opacifier pattern 120 on the second surface 114 in present embodiment, the whole photo-orientable layer 130 is affected by the second linearly-polarized ultraviolet light 230 and transfers to the second photo-alignment region 240 having the same polarization direction with the second polarization direction.

Please refer to FIG. 3B, FIG. 3B depicts a step of irradiating the photo-orientable layer 130 with the first linearly-polarized ultraviolet light 210 having the first polarization direction, which the first linearly-polarized ultraviolet light 210 is irradiated in a direction from the first surface 112 toward the second surface 114 of the primary transparent substrate 110. A region of the photo-orientable layer 130 irradiated by the first linearly-polarized ultraviolet light 210 transfers to the first photo-alignment region 220. The first linearly-polarized ultraviolet light 210 has a different polarization direction with the second linearly-polarized ultraviolet light 230, and an angle between a slow axis of the primary transparent substrate 110 and the first and second polarization direction is zero degree or 90 degrees. Because the first surface 112 includes the opacifier pattern 120 thereon, only a part of the photo-orientable layer 130 not shielded by the opacifier pattern 120 transfers to the first photo-alignment region 220 when irradiating the first linearly-polarized ultraviolet light 210 to the photo-orientable layer 130. The accumulated irradiation energy of the first linearly-polarized ultraviolet light 210 on the photo-orientable layer 130 should be higher than the accumulated irradiation energy of the second linearly-polarized ultraviolet light 230 on the photo-orientable layer 130 to change polarization direction, and the first photo-alignment region 220 will be formed. Also, a photo-alignment layer 250 with two alignment regions is formed according to the pattern on the opacifier pattern 120. In embodiments, the arrangement of the first alignment region 220 and the second alignment region 240 in the photo-alignment layer 250 is a staggered arrangement. In some embodiments, the irradiation dosage of the first linearly-polarized ultraviolet light 210 is 90 mJ/cm², and the irradiation dosage of the second linearly-polarized ultraviolet light 230 is 90 mJ/cm².

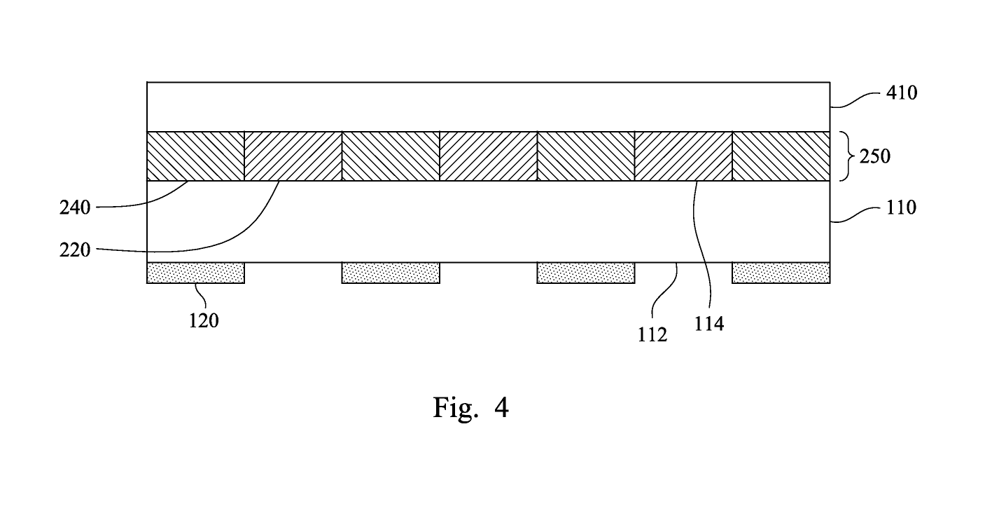

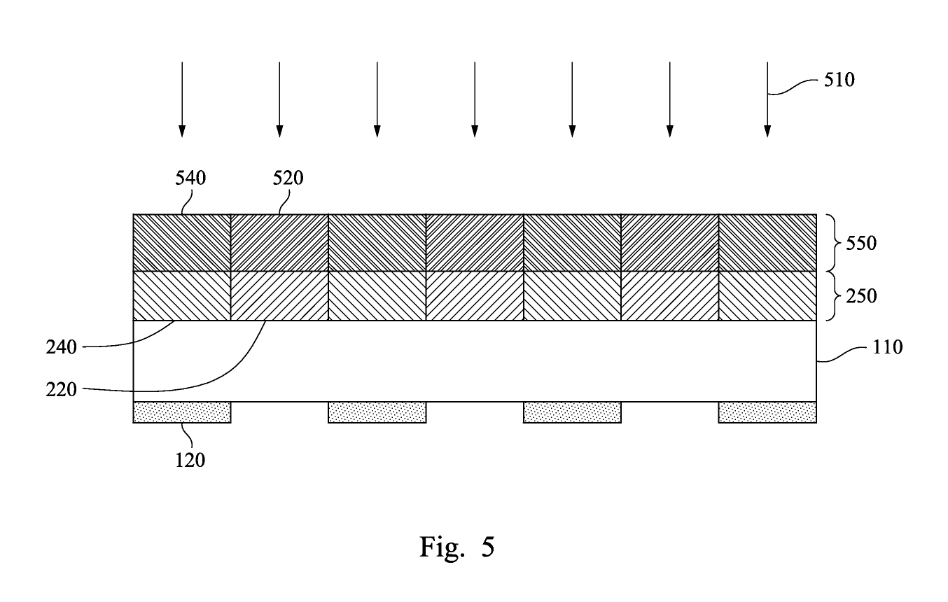

Referring to FIGS. 4 and 5, FIGS. 4 and 5 depict a step of forming a liquid crystal aligning layer 550 over the photo-alignment layer 250. The step is followed after the steps depicted in FIG. 2B or 3B. As shown in FIG. 4, FIG. 4 depicts a step of forming a liquid crystal material layer 410 over the photo-alignment layer 250. The liquid crystal material layer 410 is coated on the photo-alignment layer 250 by spin coating, bar coating, dip coating, slot die coating, roll-to-roll coating, or other coating techniques. In embodiments, after coating the liquid crystal material layer 410, an oven is applied to remove the solvent. In various embodiments, a material of the liquid crystal material layer 410 is a photo-induced cross-linking liquid crystal.

Referring to FIG. 5, FIG. 5 depicts a step of irradiating an ultraviolet light 410 to the liquid crystal material layer 410 to form the liquid crystal aligning layer 550, which an polarization direction of the liquid crystal aligning layer 550 is same with the polarization direction of the photo-alignment layer 250. The liquid crystal material layer 410 is on the photo-alignment layer 250 and induced by the polarization direction of the photo-alignment layer 250, to align the liquid crystal molecules along the same polarization direction with the photo-alignment layer 250. The liquid crystal material layer 410 is cured by irradiating the ultraviolet light 510, and the liquid crystal aligning layer 550 having the same polarization direction with the photo-alignment layer 250 is formed. At this step, the ultraviolet light 510 is a non-linearly-polarized ultraviolet light. The liquid crystal aligning layer 550 includes a first liquid crystal alignment region 520 and a second liquid crystal alignment region 540, which the first liquid crystal alignment region 520 has a same polarization direction with the first photo-alignment region 220, and the second liquid crystal alignment region 540 has a same polarization direction with the first photo-alignment region 240. In embodiments, the first liquid crystal alignment region 520 and the second liquid crystal alignment region 540 are alternatively arranged with each other.

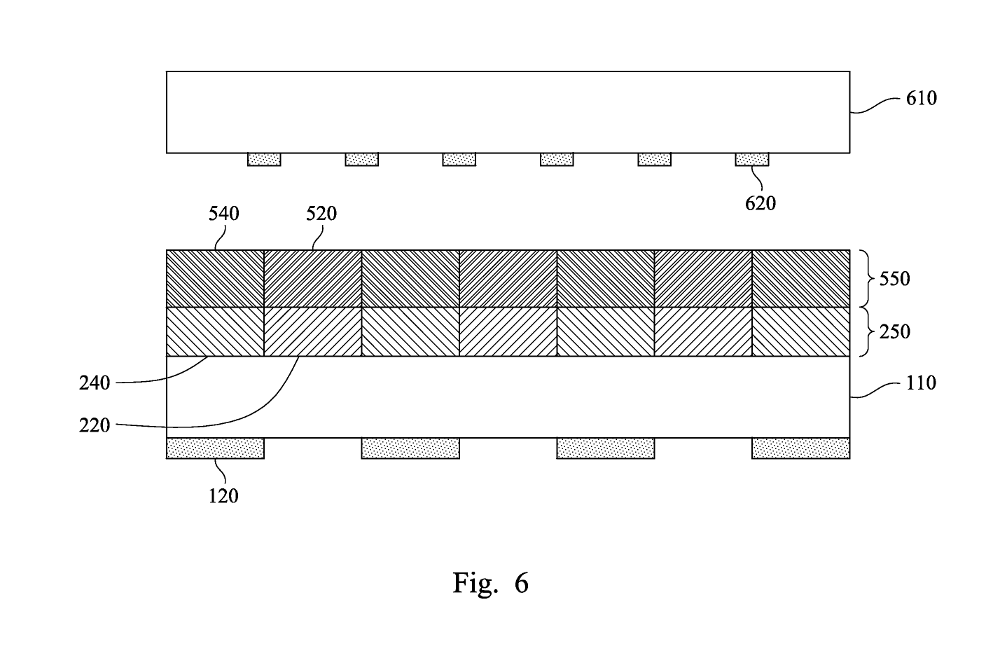

Referring to FIG. 6, FIG. 6 depicts a step of printing a plurality of opacifier stripes 620 on a secondly transparent substrate 610, which the opacifier stripes 610 align with the interface between the first liquid crystal alignment region 520 and the second liquid crystal alignment region 540. A material of the secondly transparent substrate 610 is a flexible and transparent material, which is selected form a group consisting of a polyester-based resin, a acetate-based resin, a polyethersulfone-based resin, a polycarbonate-based resin, a polyamide-based resin, polyimide-based resin, a polyolefin-based resin, an acrylic-based resin, a polyvinyl chloride-based resin, a polystyrene-based resin, a polyvinyl alcohol-based resin, a polyarylate-based resin, a polyphenylene sulfide-based resin, a polyvinylidene chloride-based resin, and a methacrylate-based resin, but not limited thereto. In some embodiments, the material of the secondly transparent substrate 610 includes a cellulose triacetate or polycarbonate.

The opacifier stripes 620 include an ultraviolet absorbent or a light-shielding ink, but not limited thereto. The ultraviolet absorbent includes benzophenone or benzotriazole, but not limited thereto. In various embodiments, the light-shielding ink includes carbon black, graphite, azo dye or phthalocyanine dye, but not limited thereto. Since the material of the opacifier stripes 620 and the opacifier material are on purpose to shield light, they may be chose from the same material. In some embodiments, the opacifier stripes 620 may be formed on the second transparent surface 610 by, but not limited to, screen printing, gravure printing or ink spraying. The opacifier stripes 620 are aligned corresponding to the interface between the first liquid crystal alignment region 520 and the second liquid crystal alignment region 540. In various embodiments, the opacifier stripes 620 have a strip-shape and arrange in parallel on the second transparent surface 610. In embodiments, a width of the opacifier stripes 620 is in a range from about 40 μm to about 120 μm, for example, 40, 50, 60, 70, 80, 90, 100, 110, or 120 μm. A thickness of the opacifier stripes 620 is in a range from about 1 μm to 10 μm, preferably 1 μm to 5 μm.

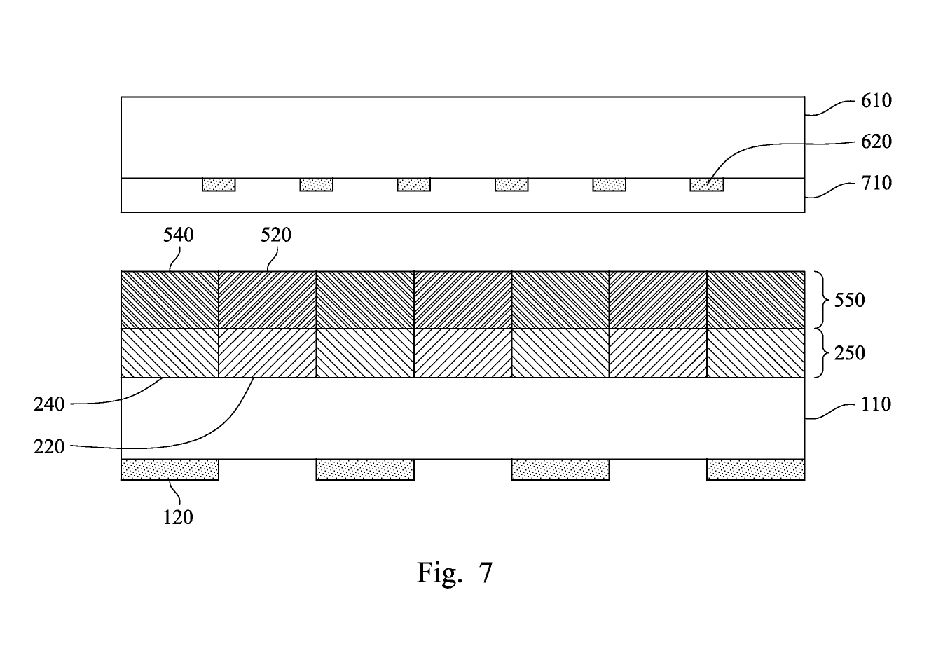

Referring to FIG. 7, FIG. 7 depicts a step of coating an adhesive layer 710 over a surface of the secondly transparent substrate 610 and surfaces of the opacifier stripes 620. A material of the adhesive layer 710 may be a transparent pressure-sensitive adhesive, which includes an acrylic pressure-sensitive adhesive, a polyurethane pressure-sensitive adhesive, a polyisobutylene pressure-sensitive adhesive, a rubber-based pressure-sensitive adhesive (such as styrene-butadiene rubber), a polyvinyl ether pressure-sensitive adhesive, an epoxy pressure-sensitive adhesive, a melamine pressure-sensitive adhesive, a polyester pressure-sensitive adhesive, a phenol pressure-sensitive adhesive, a silicon pressure-sensitive adhesive, or combinations thereof, but not limited thereto. The adhesive layer 710 may be coated according to conveniences of different embodiments, for example, spin coating, bar coating, dip coating, slot die coating, roll-to-roll coating, or other coating techniques, but not limited thereto. A thickness of the adhesive layer 710 is in a range from about 10 μm to 30 μm, for example, 10, 15, 20, 25 or 30 μm. Also, a peel strength against glass of the adhesive layer 710 is in a range from about 150 gf/mm to about 300 gf/mm, and stronger peel strength is desired to strip the liquid crystal aligning layer 550 in the following steps.

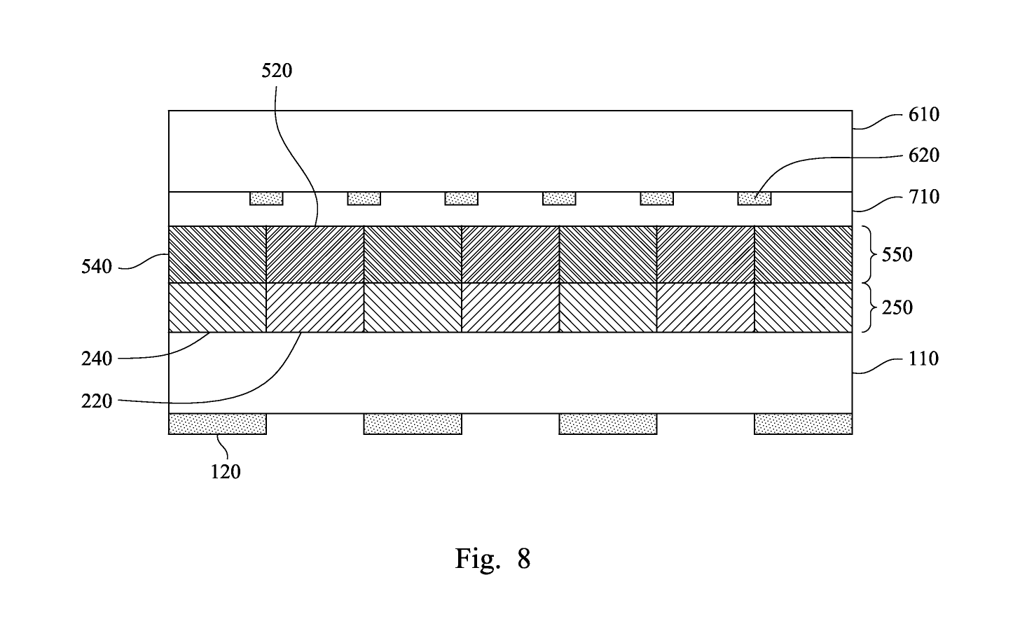

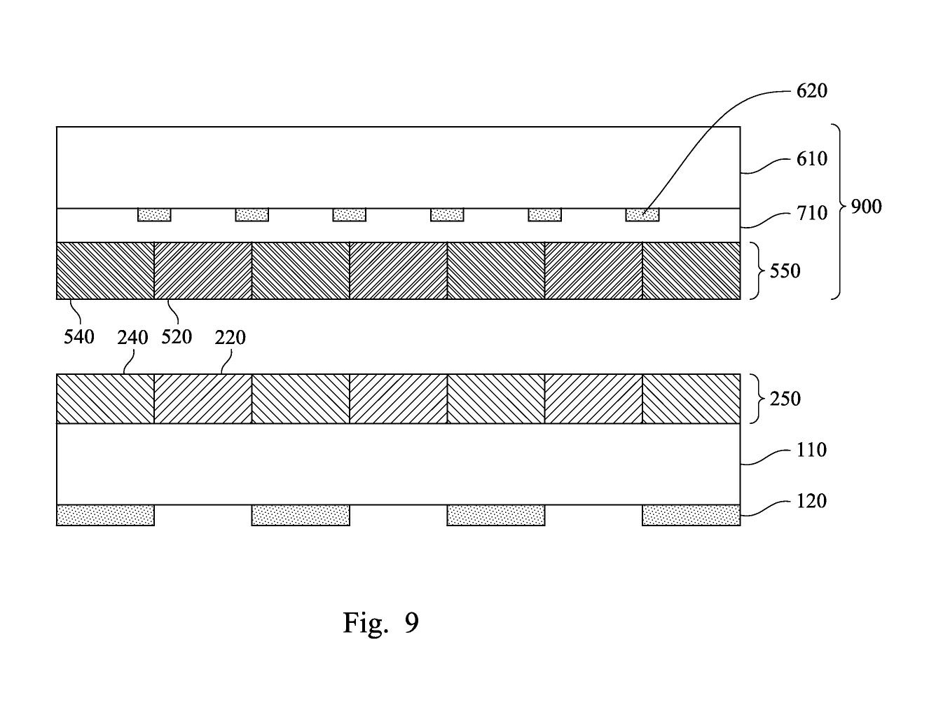

Referring to FIGS. 8 and 9, FIGS. 8 and 9 depict steps of bonding the adhesive layer 710 and the liquid crystal aligning layer 550, and then separating the liquid crystal aligning layer 550 from the primary transparent substrate 110. Please refer to FIG. 8, FIG. 8 depicts that the adhesive layer 710 is bonded to the liquid crystal aligning layer 550, to totally stick the adhesive layer 710 and the liquid crystal aligning layer 550. Following in FIG. 9, FIG. 9 depicts that the liquid crystal aligning layer 550 is separated from the primary transparent substrate 110. The liquid crystal aligning layer 550 is peeled from the primary transparent substrate 110 to separate the liquid crystal aligning layer 550 and the photo-alignment layer 250, and an a retardation film 900 is formed. The retardation film 900 includes the secondly transparent substrate 610, the adhesive layer 710, opacifier stripes 620 and the liquid crystal aligning layer 550.

FIGS. 1-9 provide embodiments of fabricating the retardation film. In present embodiments, the opacifier stripes are formed on the secondly transparent substrate to prevent possible damage for liquid crystal surface when forming the opacifier stripes directly on the liquid crystal surface. After that, the adhesive layer covers the opacifier stripes to prevent powders formed from the opacifier stripes during the drying process. These powders may damage the surface of the retardation film or show particles in the display region. Last, the adhesive layer is stick with the liquid crystal aligning layer, and the liquid crystal aligning layer is stripped from the primary transparent substrate to form the retardation film. The retardation film includes opacifier stripes positioned at the interface between different liquid crystal alignment regions in the liquid crystal aligning layer. Also, the retardation film includes alignment function, and could be applied in the roll-to-roll process. The method of fabricating the retardation film reduces the cost and enhances the process yield.

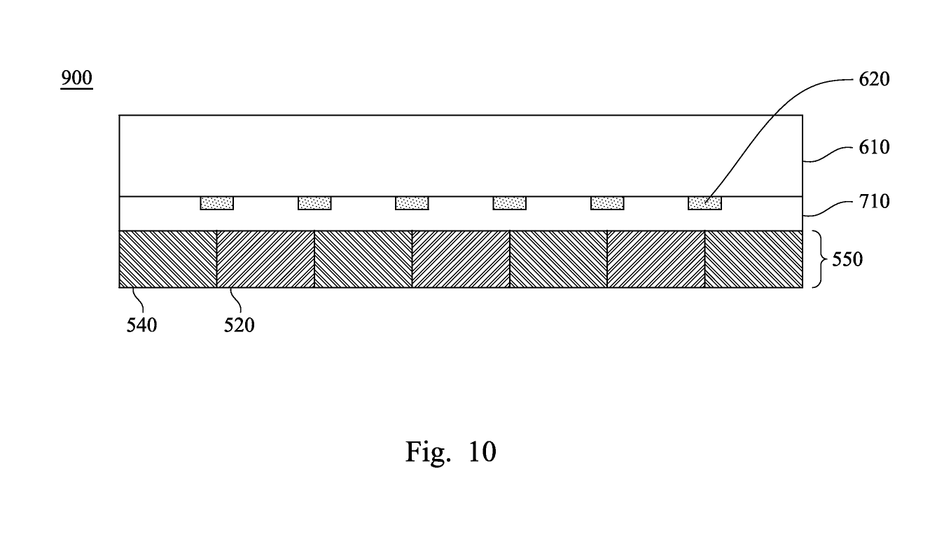

Referring to FIG. 10, FIG. 10 depicts a cross-sectional view of the retardation film, in accordance with some embodiments. The retardation film 900 includes a liquid crystal aligning layer 550 having a first liquid crystal alignment region 520 and a second liquid crystal alignment region 540, which the two liquid crystal alignment regions 520, 540 have different polarization directions and alternatively arranged with each other; an adhesive layer 710 disposed on the liquid crystal aligning layer 550; a secondly transparent substrate 610 disposed on the adhesive layer 710; and a plurality of opacifier stripes 620 disposed on a interface between the secondly transparent substrate 610 and the adhesive layer 710. Also, the opacifier stripes 620 are disposed corresponding to the interface between the first liquid crystal alignment region 520 and the second liquid crystal alignment region 540, but the opacifier stripes 620 are not in contact with the liquid crystal aligning layer 550. A thickness of the opacifier stripes 620 is in a range from about 1 μm to about 5 μm. In embodiments, the thickness of the opacifier stripes 620 is 1 μm. A width of the opacifier stripes 620 is in a range from about 40 μm to about 120 μm. In various embodiments, the width of the opacifier stripes 620 is in a range from about 50 μm to about 100 μm. A thickness of the adhesive layer 710 is in a range from about 10 μm to about 30 μm. In some embodiments, the thickness of the adhesive layer 710 is 20 μm. A material of the opacifier stripes 620 includes, but not limited to, an ultraviolet radiation absorbing agent or a light-shielding ink. A material of the secondly transparent substrates 610 includes, but not limited to, a cellulose triacetate or polycarbonate. A material of the adhesive layer 710 is transparent pressure-sensitive adhesive, includes but not limited to, an acrylic pressure-sensitive adhesive, a polyurethane pressure-sensitive adhesive, a polyisobutylene pressure-sensitive adhesive, a rubber-based pressure-sensitive adhesive, a polyvinyl ether pressure-sensitive adhesive, an epoxy pressure-sensitive adhesive, a melamine pressure-sensitive adhesive, a polyester pressure-sensitive adhesive, a phenol pressure-sensitive adhesive, a silicon pressure-sensitive adhesive, or combinations thereof.

The following examples and comparative examples are provided to illustrate embodiments of the present disclosure, and should not be construed as limiting the scope of the invention.

1. Preparation of a Light-Shielding Solution.

A binder (a thermosetting resin, catalogue no.: medium) and a toluene solvent are mixed in a ratio of 1:1 to form 10 g solution. An ultraviolet radiation absorbing agent (available from Everlight Chem. Co., catalogue no.: Eversorb51) is added into the solution in a ratio of 1:50 to form the light-shielding solution (the weight ratio of the ultraviolet radiation absorbing agent to the binder is 1:25).

2. Preparation of a Photo-Orientable Solution.

(1) Methylethylketone and cyclopentanone are mixed in a weight ratio of 1:1 to form 3.5 g mixed solvent.

(2) 0.5 g photo-induced cross-linking resin (cinnamate resin, available from Swiss Rolic Co., catalogue no.: ROP103, 10% solid content) is dissolved in the 3.5 g mixed solvent prepared in step (1) to obtain a photo-orientable solution, which has a solid content of 1.25%.

3. Preparation of a Liquid Crystal Solution

1 g liquid crystal solid (birefringence is 0.14) is added into 4 g cyclopentanone to obtain a liquid crystal solution having a solid content of 20%.

4. Preparation of a Retardation Film.

A. 32 Inch Panel

Embodiment A1: irradiating the photo-orientable layer with the first linearly-polarized ultraviolet light before irradiating the photo-orientable layer with the second linearly-polarized ultraviolet light, and the width of the opacifier stripes is 50 μm.

Method of preparating the retardation film in embodiment A1 includes following steps:

(1-1) Preparation of the Opacifier Pattern.

The light-shielding solution is gravure printed on a first surface of a polycarbonate substrate (a primary transparent substrate, having a thickness of 60 μm, a birefringence of 2.17×10⁻⁴ and a retardation of 13 nm) according to a predetermined pattern, and a printed thickness is about 1 μm. Then, the polycarbonate substrate and the light-shielding solution are baked in an oven under 60° C. for 30 seconds. Therefore, a substrate having the opacifier pattern thereon is formed, and a light transmissibility of the substrate covered by the opacifier pattern is 10%.

(1-2) Preparation of the Photo-Orientable Layer.

4 g photo-orientable solution is spin-coated (speed: 3000 rpm for 40 seconds) on a second surface of the primary transparent substrate prepared in step (1-1), which the second surface is on opposite side of the first surface. After spreading photo-orientable solution evenly on the second surface, the photo-orientable solution is baked in the oven under 100° C. for two minutes to remove the solvent. The photo-orientable layer is formed after cooling to the room temperature.

(1-3) First Irradiating.

Irradiating the photo-orientable layer prepared in step (1-2) with a first linearly-polarized ultraviolet light in a direction from the first surface toward the second surface of the primary transparent substrate (irradiation dosage of the first linearly-polarized ultraviolet light is 180 mJ/cm², as shown in FIG. 2A), which a slow axis of the primary transparent substrate forms an angle of zero degree with the first linearly-polarized ultraviolet light. A part of the photo-orientable layer irradiated by the first linearly-polarized ultraviolet light is cured and transfers to a first polarization direction, to form a first photo-alignment region. But another part of the photo-orientable layer covered by the opacifier pattern is not cured and without polarization direction. Therefore, a photo-orientable layer with staggered alignment is formed.

(1-4) Second Irradiating.

Irradiating the photo-orientable layer prepared in step (1-4) with a second linearly-polarized ultraviolet light in a direction from the second surface toward the first surface of the primary transparent substrate (irradiation dosage of the second linearly-polarized ultraviolet light is 90 mJ/cm², as shown in FIG. 2B), which a slow axis of the primary transparent substrate forms an angle of 90 degrees with the second linearly-polarized ultraviolet light. The photo-orientable layer covered by the opacifier pattern in step (1-3) is cured and has a second polarization direction, to form a second photo-alignment region. Therefore, the photo-orientable layer transfers to a photo-alignment layer having two photo-alignment regions.

(1-5) Preparation of Liquid Crystal Layer.

5 g liquid crystal solution is spin-coated (speed: 3000 rpm for 40 seconds) on the photo-alignment layer and baked in the oven under 60° C. for five minutes to remove the solvent. The liquid-crystal layer is formed after cooling to the room temperature.

(1-6) Preparation of liquid crystal aligning layer.

Irradiating a non-linearly-polarized ultraviolet light on the aforementioned liquid crystal layer (irradiation dosage of the non-linearly-polarized ultraviolet light is 120 mJ/cm²), and a nitrogen gas is applied to cure the liquid crystal layer to obtain an liquid crystal aligning layer. The liquid crystal aligning layer includes a first liquid crystal alignment region and a second liquid crystal alignment region, which the first liquid crystal alignment region has a same polarization direction with the first photo-alignment region, and the second liquid crystal alignment region has a same polarization direction with the second photo-alignment region.

(1-7) Preparation of Opacifier Stripes.

According to the opacifier pattern prepared in step (1-1), the light-shielding solution is gravure printed on a cellulose triacetate substrate (a secondly transparent substrate) to align with the interface between the two liquid crystal alignment regions, and the secondly transparent substrate having the opacifier stripes thereon is formed. A printed thickness is about 1 μm, and a printed width is about 50 μm.

(1-8) Preparation of Adhesive Layer.

10 g acrylic pressure-sensitive adhesive (solid content of 40%) is bar coated on a surface the cellulose triacetate substrate (the secondly transparent substrate), which the surface includes the opacifier stripes thereon. Then, the acrylic pressure-sensitive adhesive is baked in the over under 100° C. for two minutes to remove the solvent. An adhesive layer is formed after cooling to the room temperature. A thickness of the adhesive layer is about 20 μm, and a peel strength against glass of the adhesive layer is 200 gf/25 mm.

(1-9) Preparation of Retardation Film.

The cellulose triacetate substrate (the secondly transparent substrate, prepared in step (1-8)) having the opacifier stripes and the adhesive layer are bonded to the liquid crystal aligning layer (prepared in step (1-6)) by the adhesive layer. After bonding the adhesive layer and the liquid crystal aligning layer, the liquid crystal aligning layer is peeled from the polycarbonate substrate (the primary transparent substrate) to separate the liquid crystal aligning layer and the photo-alignment layer. Thus, a retardation film has a structure of cellulose triacetate substrate/adhesive layer/liquid crystal aligning layer, which the retardation film includes two polarization directions. Also, the opacifier stripes are respectively on an interface between the first liquid crystal alignment region and the second liquid crystal alignment region.

Embodiment A2: irradiating the photo-orientable layer with the first linearly-polarized ultraviolet light before irradiating the photo-orientable layer with the second linearly-polarized ultraviolet light, and the width of the opacifier stripes is 100 μm.

Embodiment A2 is similar to embodiment A1, the difference between the two embodiments is by changing the width of the opacifier stripes to 100 μm in step (1-7).

Embodiment A3: irradiating the photo-orientable layer with the second linearly-polarized ultraviolet light before irradiating the photo-orientable layer with the first linearly-polarized ultraviolet light, and the width of the opacifier stripes is 50 μm.

Embodiment A3 is similar to embodiment A1, the difference between the two embodiments is by changing step (1-3) and step (1-4). As described below:

(1-3) First Irradiating.

Irradiating the photo-orientable layer prepared in step (1-2) with a second linearly-polarized ultraviolet light in a direction from the second surface toward the first surface of the primary transparent substrate (irradiation dosage of the second linearly-polarized ultraviolet light is 90 mJ/cm², as shown in FIG. 3A), which the slow axis of the primary transparent substrate forms an angle of 90 degrees with the second linearly-polarized ultraviolet light. The photo-orientable layer irradiated by the second linearly-polarized ultraviolet light is cured and has a second polarization direction, to form the second photo-alignment region.

(1-4) Second Irradiating.

Irradiating the photo-orientable layer prepared in step (1-3) with the first linearly-polarized ultraviolet light in a direction from the first surface toward the second surface of the primary transparent substrate (irradiation dosage of the first linearly-polarized ultraviolet light is 90 mJ/cm², as shown in FIG. 3B), which the slow axis of the primary transparent substrate forms an angle of zero degree with the second linearly-polarized ultraviolet light. A part of the photo-orientable layer not covered by the opacifier pattern is changed from the second polarization direction to the first polarization direction, to form the first photo-alignment region.

Embodiment A4: irradiating the photo-orientable layer with the second linearly-polarized ultraviolet light before irradiating the photo-orientable layer with the first linearly-polarized ultraviolet light, and the width of the opacifier stripes is 100 μm.

Embodiment A4 is similar to embodiment A3, the difference between the two embodiments is by changing the width of the opacifier stripes to 100 μm in step (1-7).

Embodiment A5: irradiating the photo-orientable layer with the second linearly-polarized ultraviolet light before irradiating the photo-orientable layer with the first linearly-polarized ultraviolet light, and the width of the opacifier stripes is 75 μm.

Embodiment A5 is similar to embodiment A3, the difference between the two embodiments is by changing the width of the opacifier stripes to 75 μm in step (1-7).

Comparative Example A1: irradiating the photo-orientable layer with the first linearly-polarized ultraviolet light before irradiating the photo-orientable layer with the second linearly-polarized ultraviolet light, but the opacifier stripes are not applied.

Comparative Example A1 is similar to embodiment A1, the difference between the comparative example A1 and embodiment A1 is by deleting step (1-7) and changing step (1-8) and (1-9). As described below:

(1-8) Preparation of Adhesive Layer.

10 g acrylic pressure-sensitive adhesive (solid content of 40%) is bar coated on a surface the cellulose triacetate substrate (the secondly transparent substrate), and an opposite surface without coating includes an anti-glare layer. Then, the acrylic pressure-sensitive adhesive is baked in the over under 100° C. for two minutes to remove the solvent. The adhesive layer is formed after cooling to the room temperature. A thickness of the adhesive layer is about 20 μm, and peel strength against glass of the adhesive layer is 200 gf/25 mm.

(1-9) Preparation of Retardation Film.

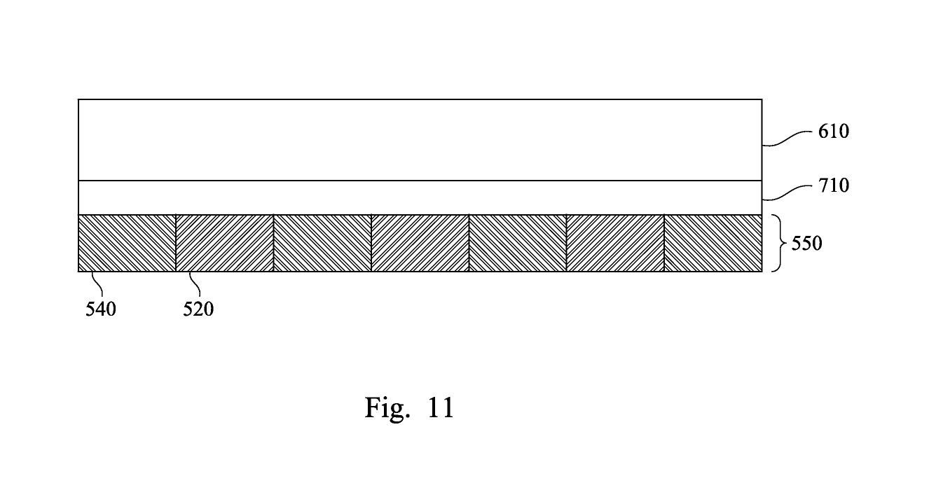

The cellulose triacetate substrate (the secondly transparent substrate, prepared in step (1-8)) is bonded to the liquid crystal aligning layer (prepared in step (1-6)) by the adhesive layer. After bonding the adhesive layer and the liquid crystal aligning layer, the liquid crystal aligning layer is peeled from the polycarbonate substrate (the primary transparent substrate) to separate the liquid crystal aligning layer and the photo-alignment layer. Thus, a retardation film having a structure of cellulose triacetate substrate/adhesive layer/liquid crystal aligning layer is formed, which the retardation film includes two polarization directions (as shown in FIG. 11).

Comparative Example A2: a quartz photomask process, irradiating the photo-orientable layer with the first linearly-polarized ultraviolet light before irradiating the photo-orientable layer with the second linearly-polarized ultraviolet light, and the width of the opacifier stripes is 50 μm.

A process of preparing the retardation film in Comparative Example A2 includes following steps:

(2-1) Preparation of the Opacifier Pattern.

A quartz photomask is provided.

(2-2) Preparation of the Photo-Orientable Layer.

4 g photo-orientable solution is spin-coated (speed: 3000 rpm for 40 seconds) on a first surface of the cellulose triacetate substrate (primary transparent substrate), which the first surface includes the anti-glare layer thereon. After spreading the photo-orientable solution evenly on the first surface, the photo-orientable solution is baked in the oven under 100° C. for two minutes to remove the solvent. The photo-orientable layer is formed after cooling to the room temperature.

(2-3) First Irradiating.

The quartz photomask is placed on the first surface, and the photo-orientable layer prepared in step (2-2) is irradiated with a first linearly-polarized ultraviolet light in a direction from the first surface toward the second surface of the primary transparent substrate (irradiation dosage of the first linearly-polarized ultraviolet light is 180 mJ/cm²), which the slow axis of the primary transparent substrate forms an angle of zero degree with the first linearly-polarized ultraviolet light. A part of the photo-orientable layer irradiated by the first linearly-polarized ultraviolet light is cured and has the first polarization direction, to form the first photo-alignment region. But another part of the photo-orientable layer covered by the quartz photomask is not cured and without polarization direction. Therefore, a photo-orientable layer with alternatively alignments is formed.

(2-4) Second Irradiating.

The photo-orientable layer prepared in step (2-3) is irradiated with the second linearly-polarized ultraviolet light in a direction from the second surface toward the first surface of the primary transparent substrate (irradiation dosage of the second linearly-polarized ultraviolet light is 90 mJ/cm²), which the slow axis of the primary transparent substrate forms the angle of 90 degrees with the second linearly-polarized ultraviolet light. The photo-orientable layer covered by the quartz photomask in step (2-3) is cured and transfers to the second polarization direction, to form the second photo-alignment region. Therefore, the photo-orientable layer transfers to a photo-alignment layer having two different photo-alignment regions.

(2-5) Preparation of Liquid-Crystal Layer.

5 g liquid crystal solution is spin-coated (speed: 3000 rpm for 40 seconds) on the photo-alignment layer and baked in the oven under 60° C. for five minutes to remove the solvent. The liquid-crystal layer is formed after cooling to the room temperature.

(2-6) Preparation of Liquid Crystal Aligning Layer.

Irradiating a non-linearly-polarized ultraviolet light on the aforementioned liquid crystal layer (irradiation dosage of the non-linearly-polarized ultraviolet light is 120 mJ/cm²), and a nitrogen gas is applied to cure the liquid-crystal layer and obtain a liquid crystal aligning layer. The liquid crystal aligning layer includes a first liquid crystal alignment region and a second liquid crystal alignment region, which the first liquid crystal alignment region has a same polarization direction with the first photo-alignment region, and the second liquid crystal alignment region has a same polarization direction with the second photo-alignment region.

(2-7) Preparation of Opacifier Stripes.

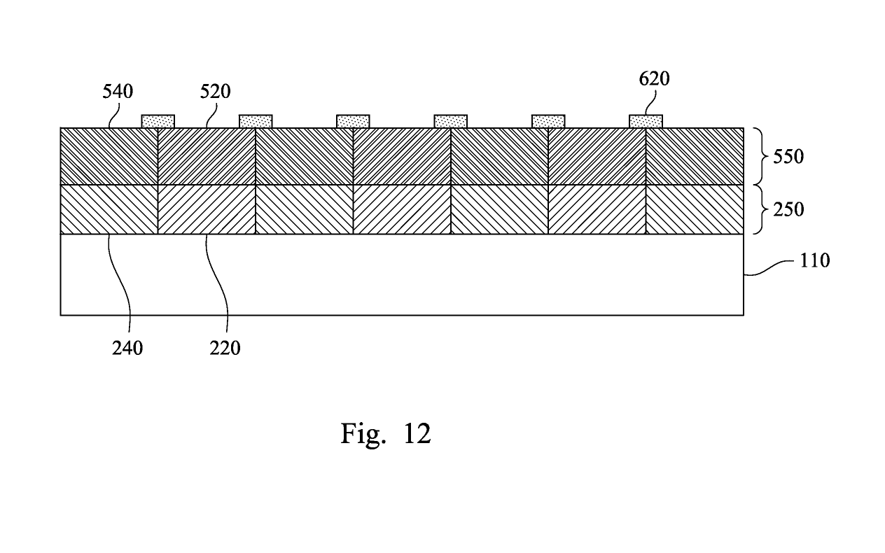

The light-shielding solution is gravure printed on the interface between the two liquid crystal alignment regions, and a structure of primary transparent substrate/photo-alignment layer/liquid crystal aligning layer is formed and having the opacifier stripes (As shown in FIG. 12).

Comparative Example A3: a quartz photomask process, irradiating the photo-orientable layer with the first linearly-polarized ultraviolet light before irradiating the photo-orientable layer with the second linearly-polarized ultraviolet light, and the width of the opacifier stripes is 100 μm.

Comparative Example A3 is similar to Comparative Example A2, the difference between the two examples is by changing the width of the opacifier stripes to 100 μm in step (2-7).

Comparative Example A4: a quartz photomask process, irradiating the photo-orientable layer with the first linearly-polarized ultraviolet light before irradiating the photo-orientable layer with the second linearly-polarized ultraviolet light, and the width of the opacifier stripes is 100 μm.

Comparative Example A4 is similar to Comparative Example A2, the difference between the two examples is by changing step (2-7). As described below:

(2-7) Preparation of Opacifier Stripes.

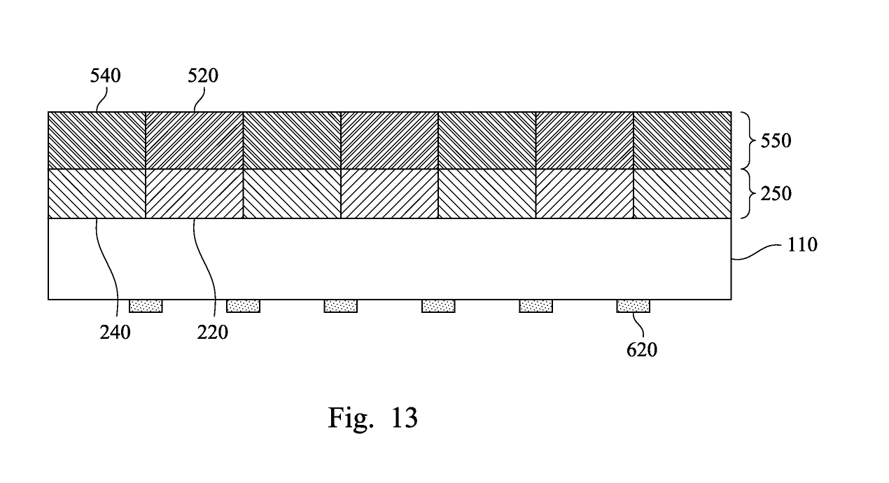

The light-shielding solution is gravure printed on a second surface (the surface including the anti-glare layer) of the primary transparent substrate corresponding to the interface between the two liquid crystal alignment regions, and a structure of primary transparent substrate/photo-alignment layer/liquid crystal aligning layer is formed and having the opacifier stripes (As shown in FIG. 13).

Comparative Example A5: irradiating the photo-orientable layer with the first linearly-polarized ultraviolet light before irradiating the photo-orientable layer with the second linearly-polarized ultraviolet light, and the width of the opacifier stripes is 150 μm.

Comparative Example A5 is similar to Embodiment A1, the difference is by changing the width of the opacifier stripes to 150 μm in step (1-7).

Comparative Example A6: irradiating the photo-orientable layer with the first linearly-polarized ultraviolet light before irradiating the photo-orientable layer with the second linearly-polarized ultraviolet light, and the width of the opacifier stripes is 200 μm.

Comparative Example A6 is similar to Embodiment A1, the difference is by changing the width of the opacifier stripes to 200 μm in step (1-7).

Comparative Example A7: irradiating the photo-orientable layer with the first linearly-polarized ultraviolet light before irradiating the photo-orientable layer with the second linearly-polarized ultraviolet light, and the width of the opacifier stripes is 250 μm.

Comparative Example A7 is similar to Embodiment A1, the difference is by changing the width of the opacifier stripes to 250 μm in step (1-7).

Comparative Example A8: irradiating the photo-orientable layer with the first linearly-polarized ultraviolet light before irradiating the photo-orientable layer with the second linearly-polarized ultraviolet light, and the width of the opacifier stripes is 300 μm.

Comparative Example A8 is similar to Embodiment A1, the difference is by changing the width of the opacifier stripes to 300 μm in step (1-7).

B. 55 Inch Panel

Embodiment B1: irradiating the photo-orientable layer with the first linearly-polarized ultraviolet light before irradiating the photo-orientable layer with the second linearly-polarized ultraviolet light, and the width of the opacifier stripes is 50 μm.

Embodiment B1 is similar to Embodiment A1, the difference is by changing the size of the panel to 55 inches.

Embodiment B2: irradiating the photo-orientable layer with the first linearly-polarized ultraviolet light before irradiating the photo-orientable layer with the second linearly-polarized ultraviolet light, and the width of the opacifier stripes is 100 μm.

Embodiment B2 is similar to Embodiment A2, the difference is by changing the size of the panel to 55 inches.

Embodiment B3: irradiating the photo-orientable layer with the second linearly-polarized ultraviolet light before irradiating the photo-orientable layer with the first linearly-polarized ultraviolet light, and the width of the opacifier stripes is 50 μm.

Embodiment B3 is similar to Embodiment A3, the difference is by changing the size of the panel to 55 inches.

Embodiment B4: irradiating the photo-orientable layer with the second linearly-polarized ultraviolet light before irradiating the photo-orientable layer with the first linearly-polarized ultraviolet light, and the width of the opacifier stripes is 100 μm.

Embodiment B4 is similar to Embodiment A4, the difference is by changing the size of the panel to 55 inches.

Embodiment B5: irradiating the photo-orientable layer with the second linearly-polarized ultraviolet light before irradiating the photo-orientable layer with the first linearly-polarized ultraviolet light, and the width of the opacifier stripes is 75 μm.

Embodiment B5 is similar to Embodiment A5, the difference is by changing the size of the panel to 55 inches.

Comparative Example B1: irradiating the photo-orientable layer with the first linearly-polarized ultraviolet light before irradiating the photo-orientable layer with the second linearly-polarized ultraviolet light, and the opacifier stripes are not applied.

Comparative Example B1 is similar to Comparative Example A1, the difference is by changing the size of the panel to 55 inches.

Comparative Example B2: irradiating the photo-orientable layer with the first linearly-polarized ultraviolet light before irradiating the photo-orientable layer with the second linearly-polarized ultraviolet light, and the width of the opacifier stripes is 150 μm.

Comparative Example B2 is similar to Embodiment B1, the difference is by changing the width of the opacifier stripes to 150 μm in step (1-7).

Comparative Example B3: irradiating the photo-orientable layer with the first linearly-polarized ultraviolet light before irradiating the photo-orientable layer with the second linearly-polarized ultraviolet light, and the width of the opacifier stripes is 200 μm.

Comparative Example B3 is similar to Embodiment B1, the difference is by changing the width of the opacifier stripes to 200 μm in step (1-7).

Comparative Example B4: irradiating the photo-orientable layer with the first linearly-polarized ultraviolet light before irradiating the photo-orientable layer with the second linearly-polarized ultraviolet light, and the width of the opacifier stripes is 250 μm.

Comparative Example B4 is similar to Embodiment B1, the difference is by changing the width of the opacifier stripes to 250 μm in step (1-7).

Comparative Example B5: irradiating the photo-orientable layer with the first linearly-polarized ultraviolet light before irradiating the photo-orientable layer with the second linearly-polarized ultraviolet light, and the width of the opacifier stripes is 300 μm.

Comparative Example B5 is similar to Embodiment B1, the difference is by changing the width of the opacifier stripes to 300 μm in step (1-7).

The liquid crystal alignment direction and retardation value of each retardation film in Embodiments and Comparative Examples are measured by the use of a phase retardation analyzer (catalogue no.: KOBRA-CCD, manufactured by Oji Scientific Instruments).

Measurement Method:

The retardation film of Embodiments and Comparative Examples are attached on the panel, which a pitch of the first and second liquid crystal alignment region in 32 inch panel is 510 μm, and a pitch of the first and second liquid crystal alignment region in 55 inch panel is 630 μm. A polarized optical microscope (POM) is applied to observe the appearance of the retardation film having defects or not. The transmissivity and vertical visual angle are measured by a brightness colorimeter (available from Tapcon, catalogue no.: SR3), and the crosstalk during measuring the vertical visual angle should be lower than 7%. The measurement of the crosstalk is described below: the left-eye pattern allocated with the right-eye glasses to measure the brightness, and the right-eye pattern allocated with the right-eye glasses to measure the brightness. Basically, the left-eye pattern allocated with the right-eye glasses should be fully dark, but if the retardation film is not aligned correctly to the panel pixel, the light leakage may be occurred. Therefore, crosstalk value should be as small as possible. The measurement results of the aforementioned Embodiments and Comparative Examples are listed in Table 1.

TABLE 1

| | opacifier | transmis- | vertical | |
|---|---|---|---|---|
| | stripes width | sivity | visual angle | |
| | (μm) | (%) | (degree) | appearance |
| 32 inch panel | | | | |
| Embodiment | 50 | 89 | 8.6 | without scratch |
| A1 | | | | or defect |
| Embodiment | 100 | 80 | 10.2 | without scratch |
| A2 | | | | or defect |
| Embodiment | 50 | 89 | 8.6 | without scratch |
| A3 | | | | or defect |
| Embodiment | 100 | 80 | 10.2 | without scratch |
| A4 | | | | or defect |
| Embodiment | 75 | 83 | 9.6 | without scratch |
| A5 | | | | or defect |
| Comparative | 0 | 100 | 7.5 | without scratch |
| Example A1 | | | | or defect |
| Comparative | 50 | 89 | 8.8 | scratch or |
| Example A2 | | | | defect |
| Comparative | 100 | 78 | 10.3 | scratch or |
| Example A3 | | | | defect |
| Comparative | 100 | 80 | 9.2 | incomplete |
| Example A4 | | | | black lines, |
| | | | | scratch or |
| | | | | defect |
| Comparative | 150 | 67 | 11.7 | without scratch |
| Example A5 | | | | or defect |
| Comparative | 200 | 56 | 13.1 | without scratch |
| Example A6 | | | | or defect |
| Comparative | 250 | 45 | 14.4 | without scratch |
| Example A7 | | | | or defect |
| Comparative | 300 | 34 | 15.8 | without scratch |
| Example A8 | | | | or defect |
| 55 inch panel | | | | |
| Embodiment | 50 | 91 | 10 | without scratch |
| B1 | | | | or defect |
| Embodiment | 100 | 82 | 11.5 | without scratch |
| B2 | | | | or defect |
| Embodiment | 50 | 91 | 10 | without scratch |
| B3 | | | | or defect |
| Embodiment | 100 | 82 | 11.5 | without scratch |
| B4 | | | | or defect |
| Embodiment | 75 | 86 | 11.3 | without scratch |
| B5 | | | | or defect |
| Comparative | 0 | 100 | 8.6 | without scratch |
| Example B1 | | | | or defect |
| Comparative | 150 | 73 | 12.8 | without scratch |
| Example B2 | | | | or defect |
| Comparative | 200 | 64 | 14.2 | without scratch |
| Example B3 | | | | or defect |
| Comparative | 250 | 55 | 15.5 | without scratch |
| Example B4 | | | | or defect |
| Comparative | 300 | 46 | 16.9 | without scratch |
| Example B5 | | | | or defect |

Effect of Irradiating Method:

Embodiments A1, A2, B1 and B2 are compared to Embodiments A3, A4, B3 and B4, which the first irradiating in Embodiments A1, A2, B1 and B2 is by the first linearly-polarized ultraviolet light, and the first irradiating in Embodiments A3, A4, B3 and B4 is by the second linearly-polarized ultraviolet light. As shown in Table 1, the retardation films prepared with these two irradiating methods have the same measurement results.

Effect of the Width of the Opacifier Stripes:

The measurement results in Table 1 are rearranged to Table 2, to show the Embodiments and Comparative Examples having the same steps with the Embodiment A1, and the difference is by changing the width of the opacifier stripes. As shown in Table 2, regardless of the panel size is 32 inches or 55 inches, the transmissivity is decreasing when the width of the opacifier stripes is increasing. Besides, the vertical visual angle is increasing when the width of the opacifier stripes is increasing. If there are no opacifier stripes on the retardation film (Comparative Example A1 and B1), the retardation film will have maximum transmittance but minimum vertical visual angle. Although increasing the width of the opacifier stripes increases the vertical visual angle, but also causes low transmissivity. It is not acceptable when the transmissivity lower than 80%, in embodiments, the width of opacifier stripes should be lower than 150 μm.

TABLE 2

| | opacifier | transmis- | Vertical | |
|---|---|---|---|---|
| | stripes width | sivity | visual angle | |
| | (μm) | (%) | (degree) | appearance |
| 32 inch panel | | | | |
| Comparative | 0 | 100 | 7.5 | without scratch |
| Example A1 | | | | or defect |
| Embodiment | 50 | 89 | 8.6 | without scratch |
| A1 | | | | or defect |
| Embodiment | 100 | 80 | 10.2 | without scratch |
| A2 | | | | or defect |
| Comparative | 150 | 67 | 11.7 | without scratch |
| Example A5 | | | | or defect |
| Comparative | 200 | 56 | 13.1 | without scratch |
| Example A6 | | | | or defect |
| Comparative | 250 | 45 | 14.4 | without scratch |
| Example A7 | | | | or defect |
| Comparative | 300 | 34 | 15.8 | without scratch |
| Example A8 | | | | or defect |
| 55 inch panel | | | | |
| Comparative | 0 | 100 | 8.6 | without scratch |
| Example B1 | | | | or defect |
| Embodiment | 50 | 91 | 10 | without scratch |
| B1 | | | | or defect |
| Embodiment | 100 | 82 | 11.5 | without scratch |
| B2 | | | | or defect |
| Comparative | 150 | 73 | 12.8 | without scratch |
| Example B2 | | | | or defect |
| Comparative | 200 | 64 | 14.2 | without scratch |
| Example B3 | | | | or defect |
| Comparative | 250 | 55 | 15.5 | without scratch |
| Example B4 | | | | or defect |
| Comparative | 300 | 46 | 16.9 | without scratch |
| Example B5 | | | | or defect |

Effect of the Method of Printing the Opacifier Stripes:

Comparative Examples A2, A3 and A4 use the quartz photomask to prepare the retardation film, the difference between the Comparative Examples A2-A4 and Embodiments A1 and A2 is described below: the quartz photomask is a hard mask needed to be removed after first irradiating, and not suitable in the roll-to-roll process. However, Embodiments A1 and A2 print the opacifier patterns on the primary transparent substrate to form the mask, which is suitable in the following roll-to-roll process. Also, the opacifier stripes are directly printed on the liquid crystal aligning layer in Comparative Examples A2 and A3, and the opacifier stripes are printed on the first surface of the primary transparent substrate in Comparative Example A4, which the first surface includes the function layer. But in Embodiments A1 and A2, the opacifier stripes are printed on the secondly transparent substrate, and the liquid crystal aligning layer is bonded to the adhesive layer.

The Comparative Example A2 and A3 are compared with Embodiments A1 and A2. Even through printing the opacifier stripes directly on the liquid crystal aligning layer could increase the vertical visual angle, it is likely to cause scratches or defects on the appearance. Also, Comparative Example A4 is compared with Comparative Example A1, which the opacifier stripes are not applied in Comparative Example A1. Even through printing the opacifier stripes on the first surface having the function layer could increase the vertical visual angle, it is also likely to cause scratches or defects. Besides, it is also hard to coat the opacifier stripes completely on the first surface, and thus induces defects on the opacifier stripes. The reason of defects or scratches formed on the appearance in Comparative Example A2-A4 is described below. After curing the liquid crystal, the liquid crystal may contact with a roller and cause scratches during the sequent process, whether the process is to the liquid crystal surface or to the non liquid crystal surface. In Comparative Example A4, the surface tension of the function layer is similar to the surface tension of the opacifier stripe material, to cause dewetting and incomplete opacifier stripes. The function layer is, for example, an anti-glare layer or a hard coat layer to prevent forming scratches on the surface. The function layer may include multi-functional methacylate, nanoparticles, photoinitiator and additive agents. Generally, the surface tension of the cellulose triacetate substrate is over than 30 mN/m, the surface tension of the function layer is less than 30 mN/m, and the surface tension of the opacifier stripes is less than 25 mN/m.

The aforementioned embodiments proves that, the method of fabricating the retardation film disclosed in present disclosure increases the vertical visual angle and also could be applied in the roll-to-roll process. Besides, the method of the adhesive layer covering the opacifier stripes and sticking to the secondly transparent substrate could prevent possible damage on cured aligned liquid crystal surface during reprocessing. Also, the method prevents powders formed from the opacifier stripes remained in the products, and thus enhances the yield of the product.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of fabricating a retardation film, comprising:
providing a primary transparent substrate;
forming a liquid crystal aligning layer over a photo-alignment layer of the primary transparent substrate, wherein the liquid crystal aligning layer comprises a first liquid crystal alignment region and a second liquid crystal alignment region, and the two liquid crystal alignment regions have different polarization directions and alternatively arranged with each other;
printing a plurality of opacifier stripes on a secondly transparent substrate, wherein the opacifier stripes align to the interface between the first liquid crystal alignment region and the second liquid crystal alignment region;
coating an adhesive layer over a surface of the secondly transparent substrate and surfaces of the opacifier stripes; and
bonding the adhesive layer to the liquid crystal aligning layer and separating the liquid crystal aligning layer from the primary transparent substrate.

2. The method of claim 1, wherein the primary transparent substrate comprises a first surface and a second surface opposite to the first surface, wherein the first surface comprises an opacifier pattern, and the second surface comprises a photo-orientable layer.

3. The method of claim 2, wherein forming the liquid crystal aligning layer over the photo-alignment layer of the primary transparent substrate comprises:
irradiating the photo-orientable layer with a linearly-polarized ultraviolet light to form the photo-alignment layer, wherein the photo-alignment layer comprises a first photo-alignment region and a second photo-alignment region, and the two photo-alignment regions are alternatively arranged with each other; and
forming the liquid crystal aligning layer over the photo-alignment layer, the liquid crystal aligning layer having a first liquid crystal alignment region and a second liquid crystal alignment region arranged alternatively with the first liquid crystal alignment region, wherein the first liquid crystal alignment region is on the first photo-alignment region, and the second liquid crystal alignment region is on the second photo-alignment region.

4. The method of claim 3, wherein irradiating the photo-orientable layer with the linearly-polarized ultraviolet light to form the photo-alignment layer comprises:
irradiating the photo-orientable layer with a first linearly-polarized ultraviolet light having a first polarization direction through the primary transparent substrate in a direction from the first surface toward the second surface of the primary transparent substrate, wherein the photo-orientable layer irradiated by the first linearly-polarized ultraviolet light transfers into the first photo-alignment region; and
irradiating the photo-orientable layer with a second linearly-polarized ultraviolet light having a second polarization direction different from the first polarization direction through the primary transparent substrate in a direction from the second surface toward the first surface of the primary transparent substrate, wherein the photo-orientable layer not irradiated by the first linearly-polarized ultraviolet light transfers into the second photo-alignment region.

5. The method of claim 4, wherein irradiating the photo-orientable layer with the linearly-polarized ultraviolet light to form the photo-alignment layer is by irradiating the photo-orientable layer with the first linearly-polarized ultraviolet light before irradiating the photo-orientable layer with the second linearly-polarized ultraviolet light, and an accumulated exposure dose of the first linearly-polarized ultraviolet light on the photo-orientable layer is higher than an accumulated exposure dose of the second linearly-polarized ultraviolet light on the photo-orientable layer.

6. The method of claim 4, wherein irradiating the photo-orientable layer with the linearly-polarized ultraviolet light to form the photo-alignment layer is by irradiating the photo-orientable layer with the second linearly-polarized ultraviolet light before irradiating the photo-orientable layer with the first linearly-polarized ultraviolet light, and an accumulated exposure dose of the first linearly-polarized ultraviolet light on the photo-orientable layer is higher than or equal to an accumulated exposure dose of the second linearly-polarized ultraviolet light on the photo-orientable layer.

7. The method of claim 4, wherein the second polarization direction of the second linearly-polarized ultraviolet light is perpendicular to the first polarization direction of the first linearly-polarized ultraviolet light during irradiating the photo-orientable layer with the linearly-polarized ultraviolet light to form the photo-alignment layer.

8. The method of claim 3, wherein forming the liquid crystal aligning layer over the photo-alignment layer comprises:
forming a liquid crystal material layer over the photo-alignment layer; and
irradiating the liquid crystal material layer with an ultraviolet light to form the liquid crystal aligning layer, wherein an polarization direction of the liquid crystal aligning layer is same with the photo-alignment layer.

9. The method of claim 1, wherein a material of the opacifier stripe comprises an ultraviolet radiation absorbing agent or a light-shielding ink.

10. The method of claim 1, wherein a width of the opacifier stripe is in a range from about 40 to about 120 μm.

11. The method of claim 1, wherein a material of the adhesive layer is a transparent pressure-sensitive adhesive.

12. The method of claim 11, wherein the transparent pressure-sensitive adhesive is selected form a group consisting of an acrylic pressure-sensitive adhesive, a polyurethane pressure-sensitive adhesive, a polyisobutylene pressure-sensitive adhesive, a rubber-based pressure-sensitive adhesive (such as styrene-butadiene rubber), a polyvinyl ether pressure-sensitive adhesive, an epoxy pressure-sensitive adhesive, a melamine pressure-sensitive adhesive, a polyester pressure-sensitive adhesive, a phenol pressure-sensitive adhesive, a silicon pressure-sensitive adhesive, and combinations thereof.

13. The method of claim 1, wherein a material of the primary and the secondly transparent substrates is selected form a group consisting of a polyester-based resin, a acetate-based resin, a polyethersulfone-based resin, a polycarbonate-based resin, a polyamide-based resin, polyimide-based resin, a polyolefin-based resin, an acrylic-based resin, a polyvinyl chloride-based resin, a polystyrene-based resin, a polyvinyl alcohol-based resin, a polyarylate-based resin, a polyphenylene sulfide-based resin, a polyvinylidene chloride-based resin, and a methacrylate-based resin.

14. The method of claim 1, wherein a material of the primary and the secondly transparent substrates comprises cellulose triacetate or polycarbonate.

15. The method of claim 2, wherein a material of the photo-orientable layer comprises a photo-orientable resin.

16. The method of claim 15, wherein the photo-orientable resin is selected from a group consisting of cinnamate derivatives, chalcone derivatives, maleimide derivatives, quinolinone derivatives, diphenylmethylene derivatives and coumarin derivatives.

17. The method of claim 2, wherein a material of the opacifier pattern comprises an ultraviolet radiation absorbing agent or a light-shielding ink.

18. A retardation film, comprising:
a liquid crystal aligning layer having a first liquid crystal alignment region and a second liquid crystal alignment region, wherein the two liquid crystal alignment regions have different polarization directions and alternatively arranged with each other;
an adhesive layer disposed on the liquid crystal aligning layer;
a transparent substrate disposed on the adhesive layer; and
a plurality of opacifier stripes disposed on a surface between the transparent substrate and the adhesive layer, wherein the opacifier stripes are disposed on the boundary between the first liquid crystal alignment region and the second liquid crystal alignment region, and the opacifier stripes are not in contact with the liquid crystal aligning layer.

19. The retardation film of claim 18, wherein a width of the opacifier stripes is in a range from about 1 to about 5 μm.

20. The retardation film of claim 18, wherein a width of the opacifier stripes is in a range from about 40 to about 120 μm.

21. The retardation film of claim 18, wherein a thickness of the adhesive layer is in a range from about 10 to about 30 μm.

22. The retardation film of claim 18, wherein a material of the opacifier stripe comprises an ultraviolet radiation absorbing agent or a light-shielding ink.
